(19) United States
(12) Patent Application Publication
(10) Pub. No.: US 2013/0335521 A1
(43) Pub. Date: Dec. 19, 2013

(54) Method of Synthesizing Stereo 3D Panorama Image and Related 3D Camera

(71) Applicant: WISTRON CORPORATION, New Taipei City (TW)

(72) Inventor: Zhao-Yuan Lin, New Taipei City (TW)

(73) Assignee: Wistron Corporation, New Taipei City (TW)

(21) Appl. No.: 13/716,202

(22) Filed: Dec. 17, 2012

(30) Foreign Application Priority Data
Jun. 13, 2012 (TW) 101121088

(51) Int. Cl. H04N 13/02

(52) U.S. Cl. CPC H04N 13/0203
USPC 348/36

(57) ABSTRACT

A method of synthesizing a stereo three-dimension (3D) panorama image for a 3D camera is disclosed. The 3D camera comprises at least two lenses. The method comprises capturing a pair image, wherein the pair image comprise a first side image and a second side image; separating the first side image and the second side image from the pair image; performing a panorama synthesis process to obtain a first side panorama image and a second side panorama image; performing a 3D synthesis process according to the first side panorama image and the second side panorama image to generate the stereo 3D panorama image; and storing and outputting the stereo 3D panorama image.

### BACKGROUND OF THE INVENTION

1. Field of the Invention

The present invention relates to a method of synthesizing panorama image and a related camera, and more particularly to a method of synthesizing stereo panorama image in 3D and a related 3D camera.

2. Description of the Prior Art

Since smart phones have been widely used recently, people have more demands for not only communications, networking but also media entertainment. Stereo three dimension (3D) technology made its debut on TV. However, Stereo 3D technology is getting more and more popular on mobile devices. Currently, each manufacturer has developed its own panorama function in photo shooting. For some models, the mobile phone system even has a built-in panorama function in video filming if the operation system has the latest update (e.g. Android Ice cream Sandwitch).

When a user uses a single lens camera, a stereo 3D panorama picture must be taken by simulation, taking a left eye image and then taking a right eye image with a bit rotation (as shown in FIG. 1). In this way, the user can obtain a 3D image only with a single lens, thereby having the stereo 3D panorama picture. However, the rotation due to simulating left and right lenses may cause distortion. Since human eyes are on the same plane, the rotation makes the field dull. If the user shift the camera in horizon to simulate the left and right eyes, it might not get much better because the left eye image and the right eye image might have a big difference or they are not in a proper position.

A 3D camera can take a side-by-side image by one shot, using a multiple lenses as shown in FIG. 2. Since the 3D camera takes photos in the view sight of human eyes, the photos can have the depth of the field. The synthesized image seen by human eyes has 3D effect since the picture is image processed to generate the binocular disparity. However, most of multi-lens cameras or 3D devices are not well developed in panorama mode or use only one of lenses while taking 3D panorama pictures, such that the 3D camera doesn't have any advantages even though it has multiple lenses.

### SUMMARY OF THE INVENTION

It is therefore an objective of the present invention to provide a method of synthesizing stereo 3D panorama image.

An embodiment of the invention discloses a method of synthesizing a stereo three-dimension (3D) panorama image for a 3D camera. The 3D camera comprises at least two lenses. The method comprises capturing a pair image, wherein the pair image comprise a first side image and a second side image; separating the first side image and the second side image from the pair image; performing a panorama synthesis process to obtain a first side panorama image and a second side panorama image; performing a 3D synthesis process according to the first side panorama image and the second side panorama image to generate the stereo 3D panorama image; and storing and outputting the stereo 3D panorama image.

An embodiment of the invention discloses a 3D camera. The 3D camera comprises at least two lenses, an image separation unit, a panorama synthesis unit, a 3D synthesis unit and a display unit. The at least two lenses are used for capturing a pair image, wherein the pair image comprise a first side image and a second side image. The image separation unit is coupled to the at least two lenses and used for separating the first side image and the second side image from the pair image. The panorama synthesis unit is coupled to the image separation unit and used for performing a panorama synthesis process to obtain a first side panorama image and a second side panorama image. The 3D synthesis unit is coupled to the panorama synthesis unit and used for performing a 3D synthesis process according to the first side panorama image and the second side panorama image to generate a stereo 3D panorama image. The display unit is coupled to the 3D synthesis unit and used for storing and outputting the stereo 3D panorama image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a single lens camera in prior art.

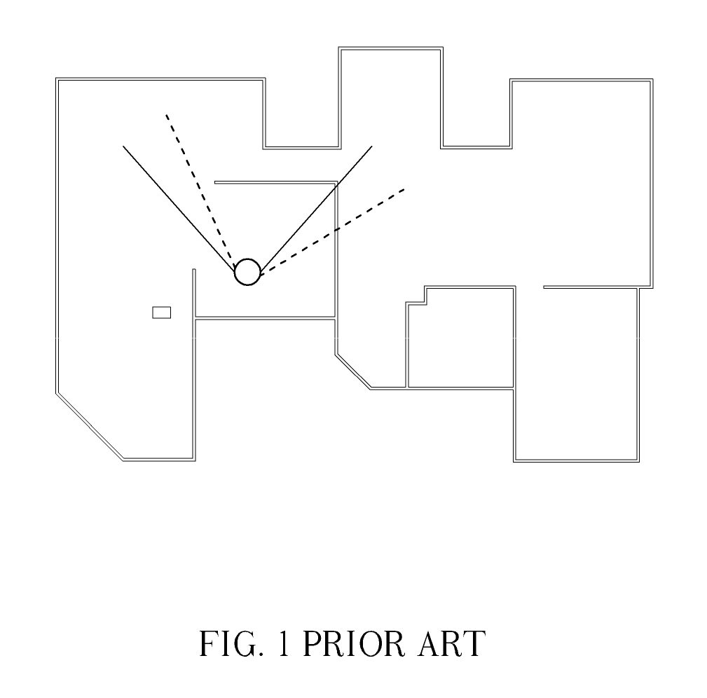

FIG. 2 is a schematic diagram of a twin lens camera in prior art.

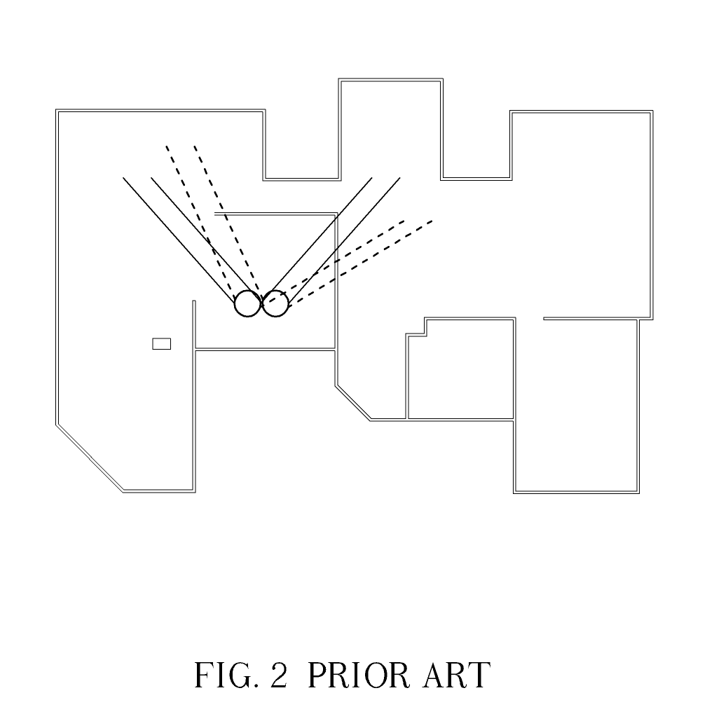

FIG. 3 is a schematic diagram of an exemplary 3D camera.

FIG. 4 illustrates multiple images according to an example of the present invention.

FIG. 5 illustrates that an exemplary display unit captures a stereo 3D panorama image.

FIG. 6 is a flowchart of an exemplary process.

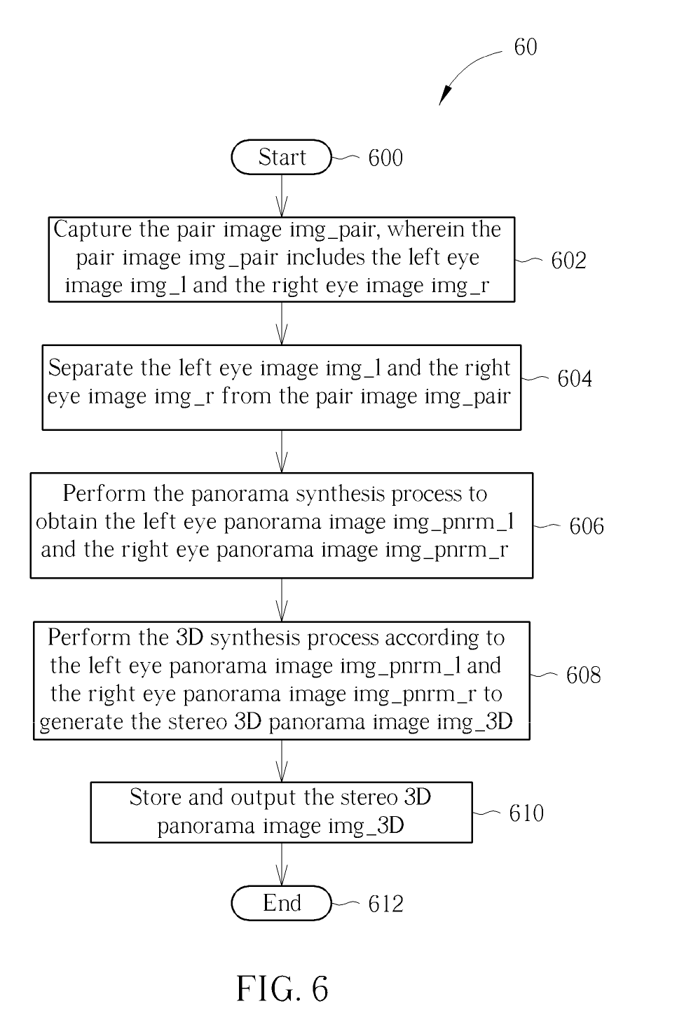

### DETAILED DESCRIPTION

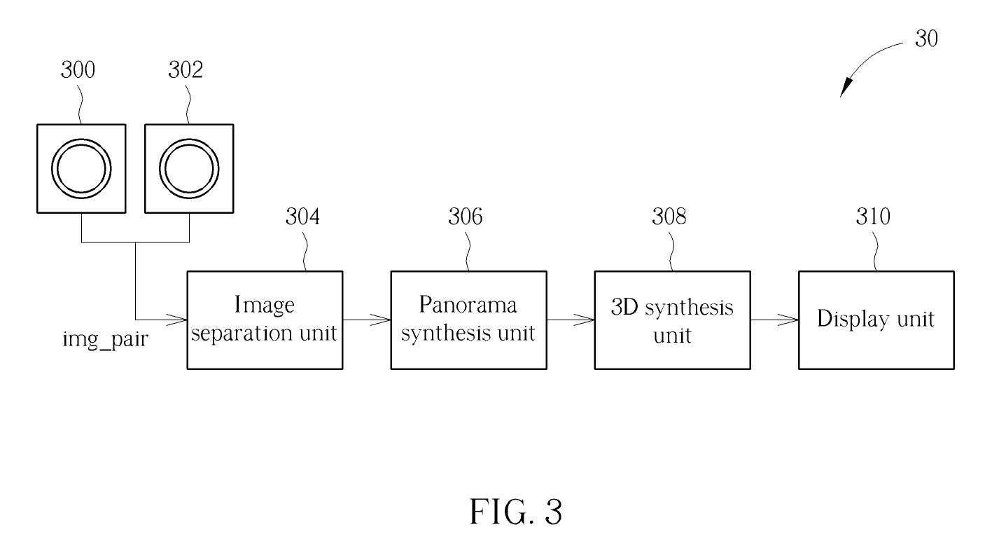

Please refer to FIG. 3, which is a schematic diagram of a 3D camera 30 according to an example of present invention. The 3D camera 30 includes a first lens 300, a second lens 302, an image separation unit 304, a panorama synthesis unit 306, a 3D synthesis unit 308 and a display unit 310. The first lens 300 and the second lens 302 are used for capturing a pair image img_pair. The pair image img_pair, preferably, has a half left right side by side format. The pair image img_pair includes a left eye image img_l and a right eye image img_r. The left eye image img_l is captured by the first lens 300 while the right eye image img_r is captured by the second lens 302. The image separation unit 304 is coupled to the first lens 300 and the second lens 302 and used for separating the left eye image img_l and the right eye image img_r from the pair image img_pair. The panorama synthesis unit 306 is coupled to the image separation unit 304 and used for performing a panorama synthesis process to obtain a left eye panorama image img_pnrm_l and a right eye panorama image img_pnrm_r. The panorama synthesis process exploits a panorama algorithm, such as SIFT (Scale-Invariant Feature Transform) and Image Stitching, to generate the left eye panorama image img_pnrm_l and the right eye panorama image img_pnrm_r. The 3D synthesis unit 308 is coupled to the panorama synthesis unit 306 and used for performing a 3D synthesis process according to the left eye panorama image img_pnrm_l and the right eye panorama image img_pnrm_r to generate a stereo 3D panorama image img_{—}3D. The display unit 310 is coupled to the 3D synthesis unit 308 and used for storing and outputting the stereo 3D panorama image img_{—}3D. Please note that the pair image img_pair can be in other side by side formats (e.g. up and down), separated into the left eye image img_l and right eye image img_r through different image separation technologies.

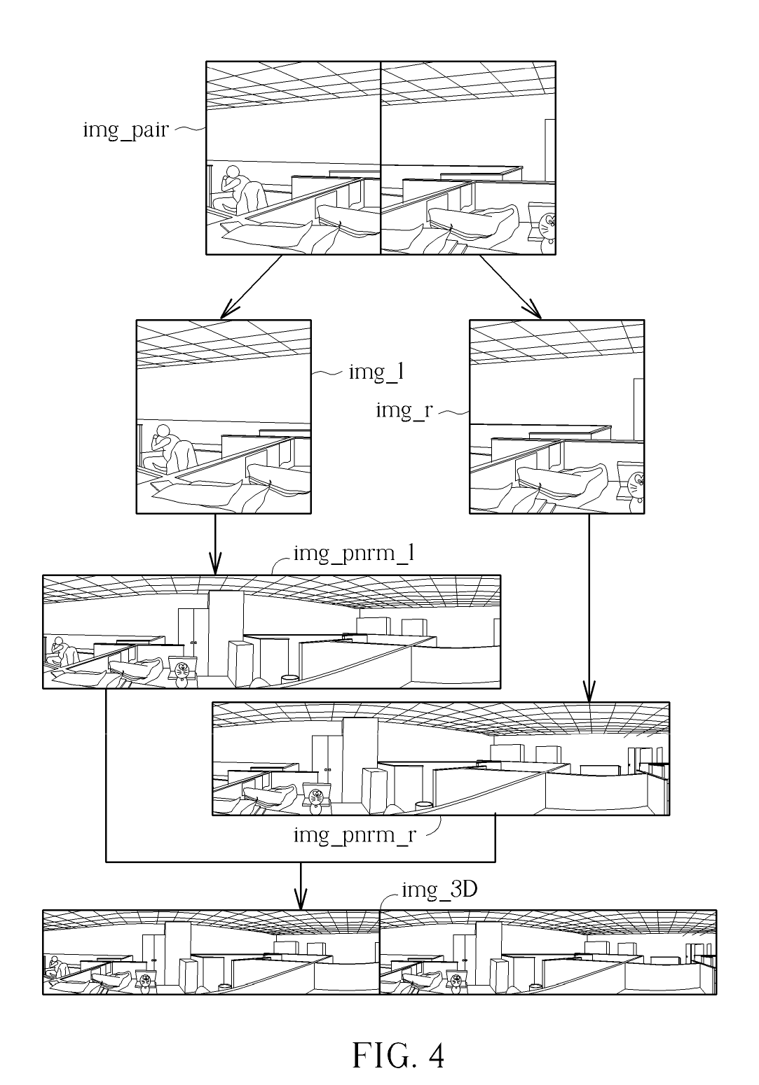

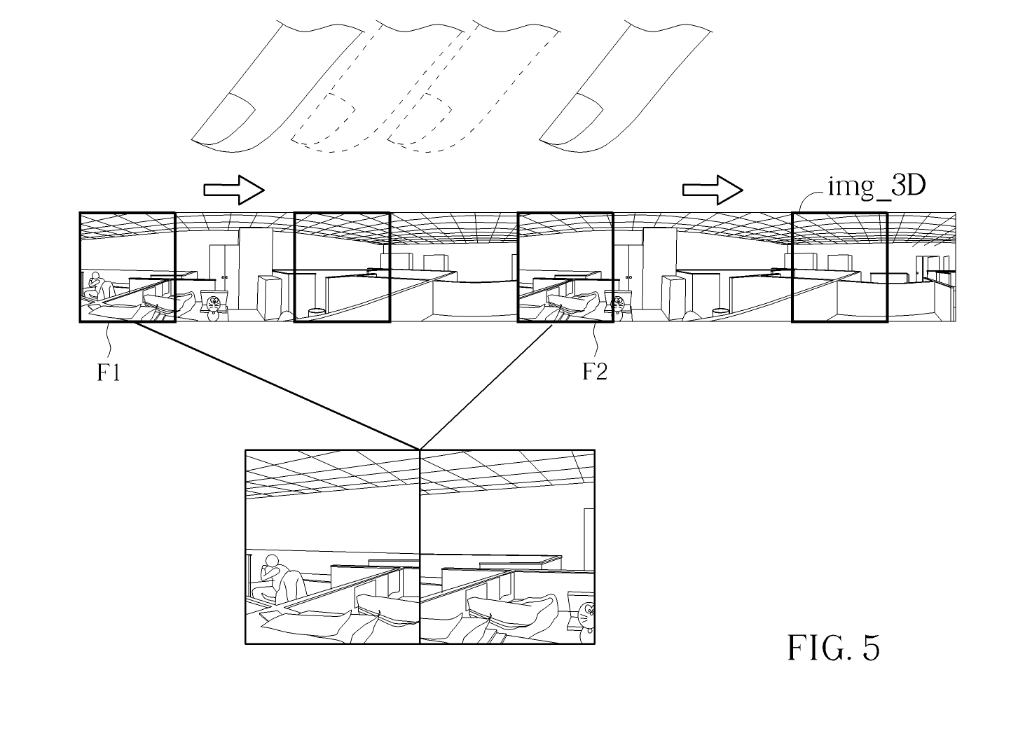

Please refer to FIG. 4 and the following description. FIG. 4 illustrates multiple images according to an example of the present invention. When a user intends to take a stereo 3D panorama image with the 3D camera 30, the first lens 300 and the second lens 302 can simulate human eyes, obtaining the pair image img_pair in half left right side by side format. Through the image separation unit 304, the pair image img_pair is separated into the left eye image img_l and the right eye image img_r. Meanwhile, the 3D camera 30 may give the user an indication to move the 3D camera 30. When the 3D camera 30 is moving, the first lens 300 and the second lens 302 consistently generate image pairs. The image separation unit 304 keeps separating each image pair into the left eye image img_l and the right eye image img_r. The panorama synthesis unit 306 performs the panorama synthesis process to stitch multiple left eye images to generate the left eye panorama image img_pnrm_l and stitch multiple right eye images to generate the right eye panorama image img_pnrm_r. The 3D synthesis unit 308 stitches a right side of the left eye panorama image img_pnrm_l and a left side of the right eye panorama image img_pnrm_l together in order to generate the stereo 3D panorama image img_{—}3D. Besides, the 3D camera 30 can store the stereo 3D panorama image img_3D in a storage unit of the 3D camera 30. As shown in FIG. 5, the display unit 310 initially captures the leftmost image frame F1 of the stereo 3D panorama image img_3D and a middle image frame F2 of the stereo 3D panorama image img_3D when the user intends to see the stereo 3D panorama image img_{—}3D. Then, the display unit 310 synthesizes the captured image frames F1 and F2 and shows the synthesis image frame on the screen. When the user drags the stereo 3D panorama image img_{—}3D on the screen with a finger, the display unit 310 correspondingly shifts the captured image frames according to the motion of the finger (along with arrow shown in FIG. 5). Thus, the stereo 3D panorama image img_{—}3D displayed on the screen can be seen in 3D by the user.

Compared to the prior art, the examples of the present invention can display the stereo 3D panorama image by using two camera lenses, thereby improving drawbacks in the prior art, for example the distortion caused by single camera lens or no panorama in 3D.

The operation of the 3D camera 30 can be synthesized into a process 60. The process 60 can be used for the 3D camera 30 to synthesis a stereo 3D panorama image. The process 60 includes the following steps:

Step 600: Start.

Step 602: Capture the pair image img_pair, wherein the pair image img_pair includes the left eye image img_l and the right eye image img_r.

Step 604: Separate the left eye image img_l and the right eye image img_r from the pair image img_pair.

Step 606: Perform the panorama synthesis process to obtain the left eye panorama image img_pnrm_l and the right eye panorama image img_pnrm_r.

Step 608: Perform the 3D synthesis process according to the left eye panorama image img_pnrm_l and the right eye panorama image img_pnrm_r to generate the stereo 3D panorama image img_{—}3D.

Step 610: Store and output the stereo 3D panorama image img_{—}3D.

Step 612: End.

The detailed description of the process 60 can be found above, thus omitted herein.

To sum up, the examples of the present invention separates a left eye image and a right eye image from each image pair after multiple image pairs are captured by multiple lenses. Through a panorama synthesis process, a left eye panorama image and a right eye panorama image can be obtained. Further, the 3D synthesis process is performed according to the left eye panorama image and the right eye panorama image to generate a stereo 3D panorama image. Lastly, the stereo 3D panorama image is stored and displayed on the 3D camera. Therefore, the examples of the present invention solve the problems that cameras in the prior art can not perform panorama in 3D or does not have 3D panorama function due to single lens. According to the examples of the present invention, the 3D camera can achievement stereo 3D panorama image.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of synthesizing a stereo three-dimension (3D) panorama image for a 3D camera, the 3D camera comprising at least two lenses, the method comprising:
capturing a pair image, wherein the pair image comprise a first side image and a second side image;
separating the first side image and the second side image from the pair image;
performing a panorama synthesis process to obtain a first side panorama image and a second side panorama image;
performing a 3D synthesis process according to the first side panorama image and the second side panorama image to generate the stereo 3D panorama image; and
storing and outputting the stereo 3D panorama image.

2. The method of claim 1, wherein the pair image is captured by the at least two lenses of the 3D camera.

3. The method of claim 1, wherein performing a 3D synthesis process according to the first side panorama image and the second side panorama image to generate the stereo 3D panorama image comprises stitching a right side of the first side panorama image and a left side of the second side panorama image to generate the stereo 3D panorama image.

4. The method of claim 1, wherein outputting the stereo 3D panorama image comprises:
capturing a first image frame and a second image frame of the stereo 3D panorama image; and
synthesizing and displaying the first image frame and the second image frame.

5. The method of claim 4, wherein the first image frame is a leftmost frame of the stereo 3D panorama image and the second image frame is a middle frame of the stereo 3D panorama image when initially outputting the stereo 3D panorama image.

6. The method of claim 4 further comprising correspondingly shifting the first image frame and the second image frame according a motion of a user finger.

7. A three-dimension (3D) camera comprising:
at least two lenses for capturing a pair image, wherein the pair image comprise a first side image and a second side image;
an image separation unit coupled to the at least two lenses, for separating the first side image and the second side image from the pair image;
a panorama synthesis unit coupled to the image separation unit, for performing a panorama synthesis process to obtain a first side panorama image and a second side panorama image;
a 3D synthesis unit coupled to the panorama synthesis unit, for performing a 3D synthesis process according to the first side panorama image and the second side panorama image to generate a stereo 3D panorama image; and
a display unit coupled to the 3D synthesis unit for storing and outputting the stereo 3D panorama image.

8. The 3D camera of claim 7, wherein the 3D synthesis unit stitches a right side of the first side panorama image and a left side of the second side panorama image to generate the stereo 3D panorama image.

9. The 3D camera of claim 7, wherein the display unit captures a first image frame and a second image frame of the stereo 3D panorama image; and synthesizes and displays the first image frame and the second image frame.

10. The 3D camera of claim 9, wherein the first image frame is a leftmost frame of the stereo 3D panorama image and the second image frame is a middle frame of the stereo 3D panorama image when the display unit initially outputs the stereo 3D panorama image.

11. The 3D camera of claim 9, wherein the display unit correspondingly shifts the first image frame and the second image frame according a motion of a user finger.

12. The 3D camera of claim 9 further comprising a storage unit for storing the stereo 3D panorama image.
